(19) United States
(12) Patent Application Publication
(10) Pub. No.: US 2010/0154193 A1
(43) Pub. Date: Jun. 24, 2010

(54) SENSING METHOD, ACCURACY CONTROL METHOD, WORKPIECE POSITIONING SYSTEM AND WORKPIECE POSITIONING METHOD

(75) Inventors: Kaoru Kitamura, Hagagun (JP); Shinichi Ohnaka, Hagagun (JP); Chiyoko Nemoto, Hagagun (JP); Haruo Machida, Hagagun (JP); Shin Koiwa, Hagagun (JP); Tadashi Goto, Hagagun (JP); Naoji Yamaoka, Hagagun (JP); Kotaro Fujikura, Hagagun (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/640,467

(22) Filed: Dec. 17, 2009

(30) Foreign Application Priority Data
Dec. 19, 2008 (JP) 2008-323834
Dec. 22, 2008 (JP) 2008-325742
Dec. 25, 2008 (JP) 2008-330493

(51) Int. Cl. B25J 9/00; B62D 65/02; B62K 19/00; B25J 9/10; B25J 9/06; B23P 11/00; G01N 3/20

(52) U.S. Cl. 29/430; 414/222.09; 414/806; 73/850

(57) ABSTRACT

Positions of predetermined spots in a frame of a motorcycle are determined by sensing all the predetermined spots in one direction from a front side or a rear side of the frame of the motorcycle by a sensing device.

### BACKGROUND OF THE INVENTION

1. Field of the Invention

The present invention relates to a sensing method. More specifically, the present invention relates to a sensing method for determining the position of a predetermined spot in a frame of a motorcycle.

In addition, the present invention relates to an accuracy control method. More specifically, the present invention relates to an accuracy control method for controlling the accuracy of a welded structure including a plurality of components.

Moreover, the present invention relates to a workpiece positioning system and a workpiece positioning method. More specifically, the present invention relates to a workpiece positioning system and a workpiece positioning method for positioning workpieces.

2. Background Art

A motorcycle manufacturing process is provided with a frame assembly step for assembling a frame of a motorcycle.

This frame assembly step includes: a positioning step of adjusting relative positions of a plurality of components; a step of temporarily welding joints of the positioned components; and a step of finally welding the temporarily welded joints.

In the foregoing positioning step, for example, components are gripped by a plurality of robots, and these robots are controlled, thereby combining the components and positioning thereof (see JP-A-2007-038334).

Further, a deviation of a frame from a reference position after temporary welding is measured, and based on this deviation, the relative positions of components are adjusted (see U.S. Pat. No. 5,155,690).

Furthermore, measurements are made on a plurality of measurement spots of a frame, thereby examining the accuracy of the frame. As a measuring apparatus for making measurements on a plurality of measurement spots of a frame, for example, there is known a measuring apparatus including: two oppositely arranged robots each having an image-taking device; and an image processing device for processing images taken by these image-taking devices (see JP-A-2005-283267). In this measuring apparatus, a frame is located between these image-taking robots, images of a through hole serving as a measurement spot formed in the frame are taken from two directions opposed to each other, and these taken images are processed by the image processing device, thus measuring the position of this through hole.

However, in the foregoing positioning step, the respective components are combined by controlling the robots. Therefore, the operations of the robots are complicated, and arms of the robots interfere with each other, for example, which might make it impossible to position the components.

Furthermore, properties such as amounts of strains caused by welding vary from one frame to another; therefore, even if a deviation of a frame falls within the allowable range before final welding, the deviation might fall outside the allowable range after the final welding. In this case, there occurred a problem that much time and effort were required for correction of the frames rejected due to final welding.

Moreover, in the above-described measuring apparatus (JP-A-2005-283267), at least two image-taking robots are required because images of a frame are taken from two directions opposed to each other, which caused problems that facilities were increased in size, resulting in an increase in cost.

### SUMMARY OF THE INVENTION

One or more embodiments of the present invention provide a workpiece positioning system and a workpiece positioning method, which are capable of easily positioning a plurality of workpieces.

According to one or more embodiments of the present invention, a workpiece positioning system (e.g., an after-mentioned frame welding system 2001) for positioning a plurality of workpieces (e.g., after-mentioned components 2011 to 2013) includes: a plurality of robots (e.g., after-mentioned gripping robots 2042); a support jig (e.g., an after-mentioned support jig 2020) capable of holding or releasing the plurality of workpieces, with the plurality of workpieces combined; and a control part (e.g., an after-mentioned control unit 2060) for controlling the plurality of robots and the support jig. The control part controls the plurality of robots to grip the plurality of workpieces placed on the support jig, and then controls the support jig to release the holding of the plurality of workpieces.

Further, according to one or more embodiments of the present invention, a workpiece positioning method for positioning a plurality of workpieces includes the steps of: disposing a support jig in a first area (e.g., an after-mentioned preset area 2030); placing the plurality of workpieces over the support jig, with the plurality of workpieces combined; causing the support jig to hold the plurality of workpieces; conveying the support jig holding the plurality of workpieces to a second area (e.g., an after-mentioned welding area 2040); gripping the plurality of workpieces, placed on the support jig, by a plurality of robots; releasing the holding of the plurality of workpieces carried out by the support jig; and adjusting relative positions and postures of the plurality of workpieces, placed on the support jig, by the plurality of robots.

According this invention, the plurality of workpieces are combined by a worker using the support jig, and then the relative positions and/or postures of the plurality of workpieces are adjusted by the plurality of robots. Hence, it is only necessary to adjust the relative positions and/or postures of the plurality of workpieces, which have already been combined, by the plurality of robots. Consequently, as compared with a conventional case in which workpieces are combined by robots, the operations of the robots can be more simplified, and therefore, the plurality of workpieces can be easily positioned.

Furthermore, since the plurality of workpieces can be positioned just by using the robots and the support jig, the system's versatility is enhanced. Moreover, during the period when the relative positions and/or postures of the plurality of workpieces are adjusted in the second area, an operation for placing different workpieces over the support jig can be carried out in the first area, thus enabling an improvement in operating efficiency.

It should be noted that after the relative positions and postures of the plurality of workpieces have been adjusted, joints of the workpieces may be welded to each other, and the welded workpieces may be conveyed to an area for a subsequent step by at least one of the plurality of robots.

After the relative positions and postures of the plurality of workpieces have been adjusted, the joints of the workpieces are welded to each other, and the welded workpieces are conveyed to the area for the subsequent step by at least one of the plurality of robots. Upon conveyance of the welded workpieces to the area for the subsequent step, the support jig remains in the second area. Hence, this support jig is utilized again, and thus it is only necessary to prepare the two support jigs in total, which results in a reduction in manufacturing cost.

Further, one or more embodiments of the present invention provide an accuracy control method capable of preventing a deviation of a workpiece from falling outside the allowable range after final welding.

According to one or more embodiments of the present invention, an accuracy control method for controlling accuracy when a plurality of workpieces (e.g., after-mentioned components 1011 to 1014) are assembled and welded includes the steps of: positioning the plurality of workpieces (e.g., after-mentioned Step S1); temporarily welding the positioned workpieces to each other (e.g., after-mentioned Step S2); finally welding the temporarily welded workpieces to each other (e.g., after-mentioned Step S3); and measuring the finally welded workpieces to determine deviations of the workpieces from reference positions, and feeding back the determined deviations to the step of positioning (e.g., after-mentioned Steps S4 and S5).

In the method of the foregoing embodiment, the plurality of workpieces are positioned, and the positioned workpieces are temporarily welded to each other. Then, the temporarily welded workpieces are finally welded to each other, the finally welded workpieces are measured, deviations of the workpieces from the reference positions are determined, and the determined deviations are fed back to the step of positioning. In this manner, the deviations measured after the final welding are fed back to the step of positioning, thus making it possible to prevent the deviations of the workpieces from falling outside the allowable range after the final welding.

Moreover, one or more embodiments of the present invention provide a sensing method capable of determining the position of a predetermined spot in a frame at a low cost.

According to one or more embodiments of the present invention, a sensing method for determining positions of predetermined spots (e.g., after-mentioned measurement points A to J) in a frame (e.g., an after-mentioned frame 10) of a motorcycle includes the step of performing sensing on all the predetermined spots in one direction from the front side or rear side of the frame by a sensing device (e.g., an after-mentioned measuring device 60).

In this embodiment, examples of the sensing device include a measuring device that utilizes laser light, ultrasound, infrared rays, a camera, etc. The motorcycle frame is three-dimensionally formed with a rod-like member, and when the frame is viewed in one direction from the front side or rear side thereof, all the spots serving as the measurement targets of the frame can be visually recognized. In one or more embodiments of the present invention, sensing is performed on the predetermined spots of the frame in one direction from the front side or rear side of the frame by the sensing device. Hence, sensing can be performed on the frame by the single sensing device, thus enabling the size reduction of a sensing system and realizing a reduction in cost.

Sensing may be performed from the rear side of the frame by the sensing device.

There are cases where in order to improve the measurement accuracy of the frame, a head tube located at the front wheel side of the frame is held by a holding device, and measurements are made on the frame with the frame fixed in the same posture as that in a completed vehicle. In such a case, when sensing is performed from the front side of the frame, the head tube and the holding device might become obstacles to the sensing, and the visual recognition of all the measurement spots of the frame might not be enabled. Therefore, in one or more embodiments of the present invention, sensing is performed on the frame from the rear side of the frame. Hence, even if the frame is fixed in the same posture as that in a completed vehicle, all the predetermined spots of the frame can be visually recognized, and sensing can be reliably performed on the frame.

In this case, robots (e.g., after-mentioned third gripping robots 50) having hands (e.g., after-mentioned hands 51) provided with targets (e.g., after-mentioned target plates R to U) may be prepared, and the frame may be gripped by the hands of the robots. In this state, sensing may be performed on the targets by the sensing device, and based on results obtained by the sensing, the positions of the predetermined spots may be determined.

When sensing is performed by lifting the frame using robots, the predetermined spots, which are measurement targets, might be hidden by the arms and/or hands of the robots, and sensing might not be enabled. Therefore, according to one or more embodiments of this invention, the hands are provided with the targets, and sensing is performed on these targets by the sensing device. When the frame is gripped by the hands of the robots, the relative positions of the hands of the robots and the frame remain constant, and therefore, the positions of the predetermined spots are determined based on the positions of the targets on which the sensing has been performed. Hence, even if the predetermined spots are hidden by the arms and/or hands of the robots, sensing can be reliably performed on the frame.

Other aspects and advantages of the invention will be apparent from the following description, the drawings and the claims.

### BRIEF DESCRIPTION OF THE DRAWINGS

FIG. 1 is a perspective view illustrating a measuring system to which a sensing method according to a first exemplary embodiment is applied.

FIG. 2 is a perspective view of a frame serving as a target for sensing by the measuring system according to the first exemplary embodiment.

FIG. 3 is a perspective view of a frame according to a second exemplary embodiment.

FIGS. 4A and 4B are diagrams for describing a sensing method according to a variation of the first exemplary embodiment.

FIGS. 5A and 5B are diagrams for describing a sensing method according to a variation of the second exemplary embodiment.

FIG. 6 is a perspective view illustrating a frame examination system according to a third exemplary embodiment.

FIG. 7 is a perspective view of a frame according to the third exemplary embodiment.

FIG. 8 is a flow chart for describing an accuracy control method for the frame according to the third exemplary embodiment.

FIG. 9 is a perspective view schematically illustrating a frame welding system according to a fourth exemplary embodiment.

FIG. 10 is a perspective view of a frame welded by the frame welding system according to the fourth exemplary embodiment.

FIG. 11 is a side view of a support jig according to the fourth exemplary embodiment.

FIG. 12 is a front view of the support jig according to the fourth exemplary embodiment.

FIG. 13 is a flow chart for the frame welding system according to the fourth exemplary embodiment.

### DETAILED DESCRIPTION OF THE EXEMPLARY EMBODIMENTS

Hereinafter, exemplary embodiments of the present invention will be described with reference to the drawings. It should be noted that in describing the following exemplary embodiments, the same constituent elements are denoted by the same reference numerals and signs, and the description thereof will be omitted or simplified.

### First Exemplary Embodiment

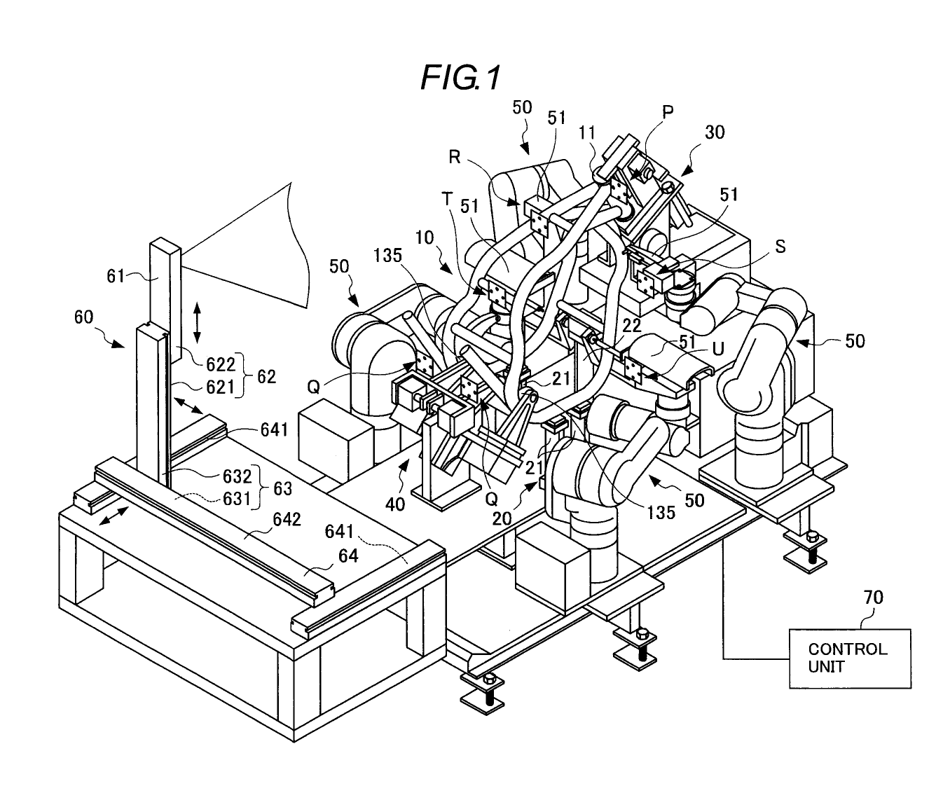

FIG. 1 is a perspective view illustrating a measuring system 1 to which a sensing method according to a first exemplary embodiment of the present invention is applied. The measuring system 1 measures, when a frame 10 is welded, the accuracy of welding performed on this frame 10. This measuring system 1 includes: a support device 20 for supporting the frame 10; a first gripping robot 30 located at the front of this support device 20; a second gripping robot 40 located at the rear of the support device 20; four third gripping robots 50 located to surround the support device 20; and a measuring device 60 functioning as a sensing device located behind the second gripping robot 40.

Further, these first gripping robot 30, second gripping robot 40, four third gripping robots 50 and measuring device 60 are controlled by a control unit 70.

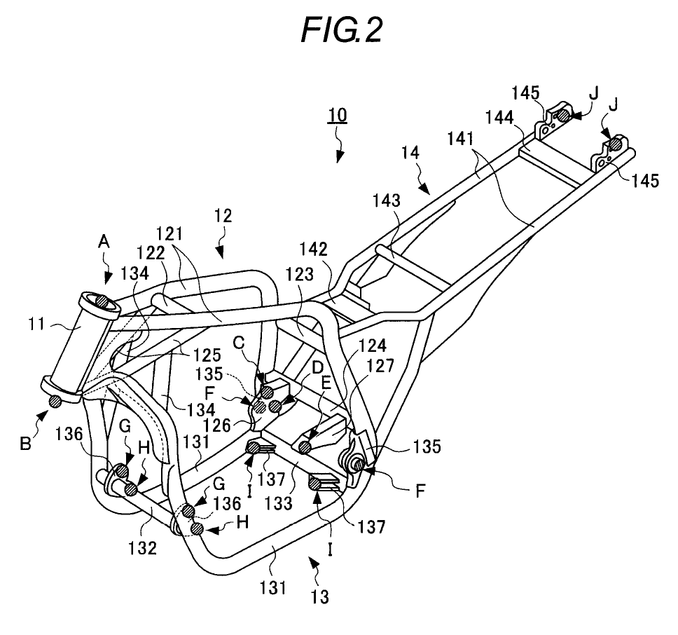

FIG. 2 is a perspective view of the frame 10. The frame 10 is a frame of a motorcycle, and includes the following four components: a head tube 11; an engine upper part 12; an engine lower part 13; and a rear part 14.

The head tube 11 supports a front fork including a front wheel and a steering wheel. This head tube 11 is formed into a cylindrical shape, and its upper side portion is inclined rearward. This head tube 11 is provided, at its upper and lower ends, with measurement points A and B, respectively.

The engine upper part 12 includes: a pair of engine upper frames 121 extending rearward from the head tube 11; three connection frames 122, 123 and 124 through which a pair of these engine upper frames 121 are connected; and a pair of sub-frames 125 extending rearward from the head tube 11 to reach points somewhere along the pair of engine upper frames 121.

Each engine upper frame 121 is approximately L-shaped so as to be extended approximately horizontally rearward from the head tube 11 and then bent to extend downward. A pair of protrusive pieces 126 and 127 is formed at the lowermost connection frame 124. The protrusive piece 126 at the back of FIG. 2 is provided with two measurement points C and D, while the protrusive piece 127 at the front of FIG. 2 is provided with a single measurement point E.

The engine lower part 13 includes: a pair of engine lower frames 131 extending downward and rearward from the sub-frames 125 of the engine upper part 12; two connection frames 132 and 133 through which a pair of these engine lower frames 131 are connected; and a pair of sub-frames 134 extending from the sub-frames 125 of the engine upper part 12 to reach points somewhere along the pair of engine lower frames 131. The engine lower frames 131 are each approximately U-shaped so as to be extended downward from the head tube 11 and subsequently bent to extend approximately horizontally rearward; then, the engine lower frames 131 are each bent to extend upward.

The respective engine upper frames 121 of the engine upper part 12 abut against these engine lower frames 131. Pivots 135 are formed at the respective abutted portions, and the pivots 135 are each provided with a measurement point F.

A pair of protrusive pieces 136 is formed at the most forward connection frame 132, and each protrusive piece 136 is provided with two measurement points G and H. Further, a pair of protrusive pieces 137 is formed at the lowermost connection frame 133, and each protrusive piece 137 is provided with a measurement point I.

The rear part 14 includes: a pair of rear frames 141 extending approximately horizontally rearward from the connection frame 123 of the engine upper part 12; and three connection frames 142, 143 and 144 through which a pair of these rear frames 141 are connected. The respective engine lower frames 131 of the engine lower part 13 abut against these rear frames 141. A pair of protrusive pieces 145 is formed at the tip end side of the pair of rear frames 141, and each protrusive piece 145 is provided with a measurement point J.

Referring again to FIG. 1, the support device 20 includes: four first support bases 21 on which the pair of engine lower frames 131 of the frame 10 is placed horizontally; and a single second support base 22 on which the connection frame 132 of the frame 10 is placed. The first gripping robot 30 vertically grips the head tube 11 of the frame 10 to adjust the position and posture of this head tube 11. This first gripping robot 30 is provided with a target plate P. The second gripping robot 40 grips the pair of pivots 135 of the frame 10 by horizontally inserting an unillustrated pin thereinto. This second gripping robot 40 is provided with two target plates Q. The four third gripping robots 50 each have five axes, and hands 51 of the four third gripping robots 50 are provided with target plates R, S, T and U.

The measuring device 60 not only measures the positions of the measurement points A to J of the frame 10 but also measures the positions of the target plates P to U. This measuring device 60 includes: an image-taking device 61 that is a camera; a height position adjustment mechanism 62 for adjusting the height position of this image-taking device 61 from a floor; a first horizontal position adjustment mechanism 63 for adjusting the position of this height position adjustment mechanism 62 in the widthwise direction of the frame 10; and a second horizontal position adjustment mechanism 64 for adjusting the position of this first horizontal position adjustment mechanism 63 in the lengthwise direction of the frame 10.

The height position adjustment mechanism 62 includes: a slide rail 621 that extends approximately perpendicularly; and a slide part 622 that supports the image-taking device 61 and moves along the slide rail 621. The first horizontal position adjustment mechanism 63 includes: a slide rail 631 extending approximately horizontally in the widthwise direction of the frame 10; and a slide part 632 that supports the slide rail 621 of the height position adjustment mechanism 62 and moves along the slide rail 631. The second horizontal position adjustment mechanism 64 includes: a pair of slide rails 641 extending approximately horizontally in the lengthwise direction of the frame 10; and a slide part 642 that supports the slide rail 631 of the first horizontal position adjustment mechanism 63 and moves along the slide rails 641.

Next, a first procedure for measurement of the foregoing frame 10 will be described. As illustrated in FIG. 1, in Step S11, the frame 10 for which welding has been completed is set onto the support device 20. In this state, when the frame is viewed from the rear side thereof, all the measurement points A to J, which are measurement targets of the frame, can be visually recognized. In Step S12, the gripping robots 30 and 40 are controlled by the control unit 70, thereby gripping the frame 10 placed over the support device 20.

In Step S13, measurements are made on the positions of the measurement points A to J of the frame 10, and based on the measurement results, deviations of the measurement points A to J of the frame 10 from reference positions are determined, thus measuring the accuracy of the frame 10.

Next, a second procedure for measurement of the foregoing frame 10 will be described. In Step S21, the frame 10 is set onto the support device 20. In this state, when the frame is viewed from the rear side thereof, all the measurement points A to J, which are measurement targets of the frame, can be visually recognized. In Step S22, the gripping robots 50 are controlled by the control unit 70, thereby gripping the frame 10 placed over the support device 20 and lifting the frame 10. Then, the measurement points A to J, which are measurement targets, might be hidden by the arms and/or hands 51 of the gripping robots 50, and might be prevented from being subjected to sensing.

To cope with this, in Step S23, sensing is performed on the target plates R to U by the measuring device 60. Furthermore, when the frame 10 is gripped by the hands 51 of the gripping robots 50, the relative positions of the hands 51 of the gripping robots 50 and the frame 10 remain constant. Therefore, based on the positions of the target plates R to U on which the sensing has been performed, the positions of the measurement points A to J of the frame 10 are determined. Deviations of the determined measurement points A to J from the reference positions are obtained, thus measuring the accuracy of the frame 10.

According to the first exemplary embodiment, the following effects are achieved.

(I) Sensing is performed on the measurement points A to J of the frame 10 from the rear side of the frame 10 by the measuring device 60. Hence, since the sensing can be performed on the frame 10 by the single measuring device 60, the size reduction of the measuring system 1 is enabled, resulting in a reduction in cost.

(II) Sensing is performed on the measurement points A to J of the frame 10 from the rear side of the frame 10; therefore, even if the frame 10 is fixed in the same posture as that in a completed vehicle, all the measurement points A to J of the frame 10 can be visually recognized, and the sensing can be reliably performed on the frame 10.

(III) The hands 51 are provided with the target plates R to U, and sensing is performed on these target plates R to U by the measuring device 60. Then, based on the positions of the target plates R to U on which the sensing has been performed, the positions of the measurement points A to J of the frame 10 are determined. Hence, even if the measurement points A to J are hidden by the arms and/or hands 51 of the gripping robots 50, the sensing can be reliably performed on the frame 10.

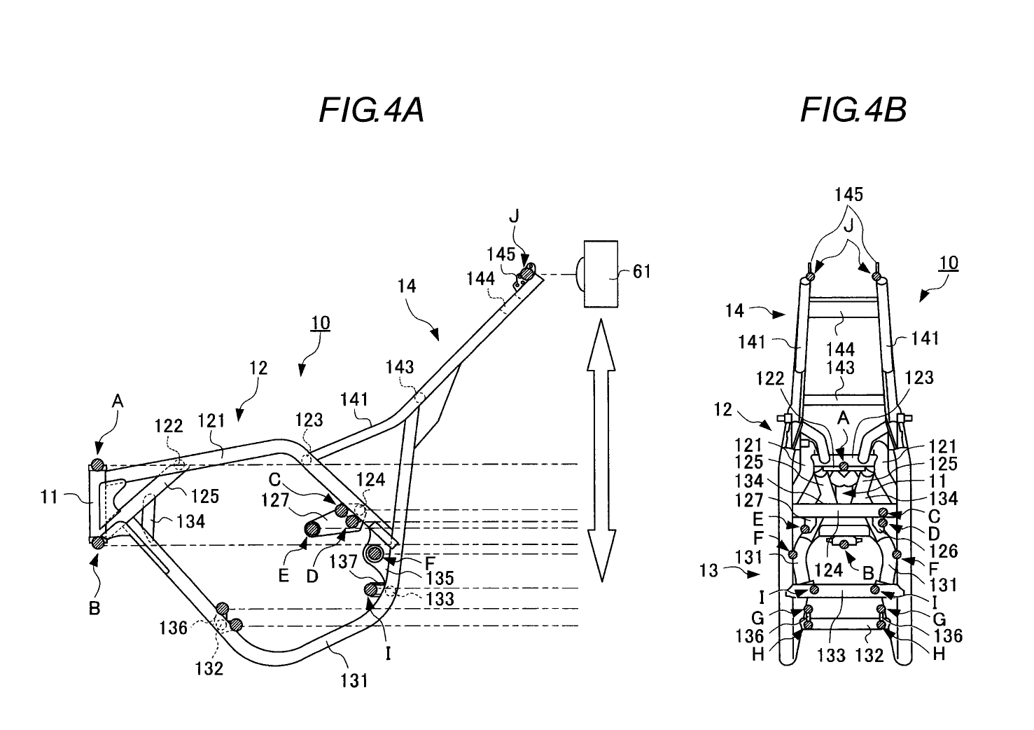

It should be noted that in the first exemplary embodiment, the sensing is performed on the frame 10 with the pair of engine lower frames 131 of the frame 10 horizontally positioned, i.e., with the upper side portion of the head tube 11 inclined rearward, but the present invention is not limited to this structure. Alternatively, as illustrated in FIGS. 4A and 4B, sensing may be performed on the frame 10 with the head tube 11 approximately perpendicularly positioned.

### Second Exemplary Embodiment

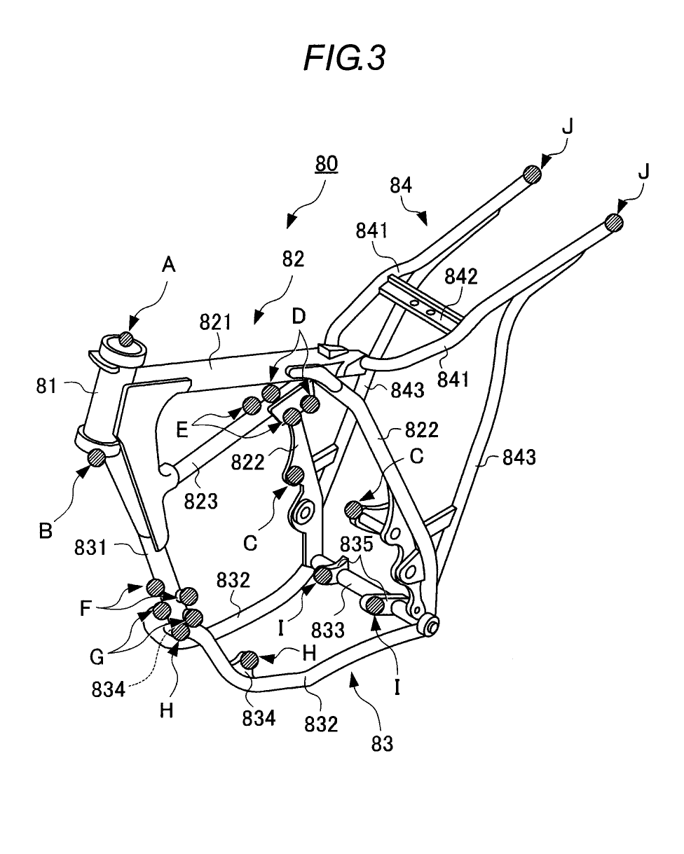

FIG. 3 is a perspective view of a frame 80. The structure of the frame 80 according to a second exemplary embodiment is different from that of the frame according to the first exemplary embodiment. The frame 80 includes: a head tube 81; an engine upper part 82; an engine lower part 83; and a rear part 84.

The head tube 81 is formed into a cylindrical shape, and its upper side portion is inclined rearward. This head tube 81 is provided, at its upper and lower ends, with measurement points A and B, respectively.

The engine upper part 82 includes: an engine upper frame 821 extending approximately horizontally rearward from the head tube 81; a pair of branching frames 822 branching off from a tip of this engine upper frame 821 and extending downward therefrom; and a sub-frame 823 extending forward from the tip of the engine upper frame 821.

Each of the pair of branching frames 822 is provided with a measurement point C. Lateral faces of the sub-frame 823 are each provided with two measurement points D and E.

The engine lower part 83 includes: an engine lower frame 831 extending downward and rearward from the head tube 81; a pair of branching frames 832 branching off from this engine lower frame 831 and extending approximately horizontally rearward; and a single connection frame 833 through which tips of these branching frames 832 are connected to each other.

The sub-frame 823 of the engine upper part 82 abuts against the base end side of this engine lower frame 831. Furthermore, the branching frames 822 of the engine upper part 82 each abut against the tip end side of the pair of branching frames 832.

Lateral faces of the engine lower frame 831 at its lower portion are each provided with two measurement points F and G. A protrusive piece 834 is formed at each of the branching frames 832, and each protrusive piece 834 is provided with a measurement point H. A pair of protrusive pieces 835 is formed at the connection frame 833, and each protrusive piece 835 is provided with a measurement point I.

The rear part 84 includes: a pair of rear frames 841 extending approximately horizontally rearward from the tip of the engine upper frame 821 of the engine upper part 82; a single connection frame 842 through which a pair of these rear frames 841 is connected; and a pair of sub-frames 843 extending from the pair of rear frames 841 to reach the tips of the branching frames 832 of the engine lower part 83. Each of the pair of rear frames 841 is provided at its tip with a measurement point J.

According to the second exemplary embodiment, effects similar to the effects (I) to (III) of the first exemplary embodiment are achieved.

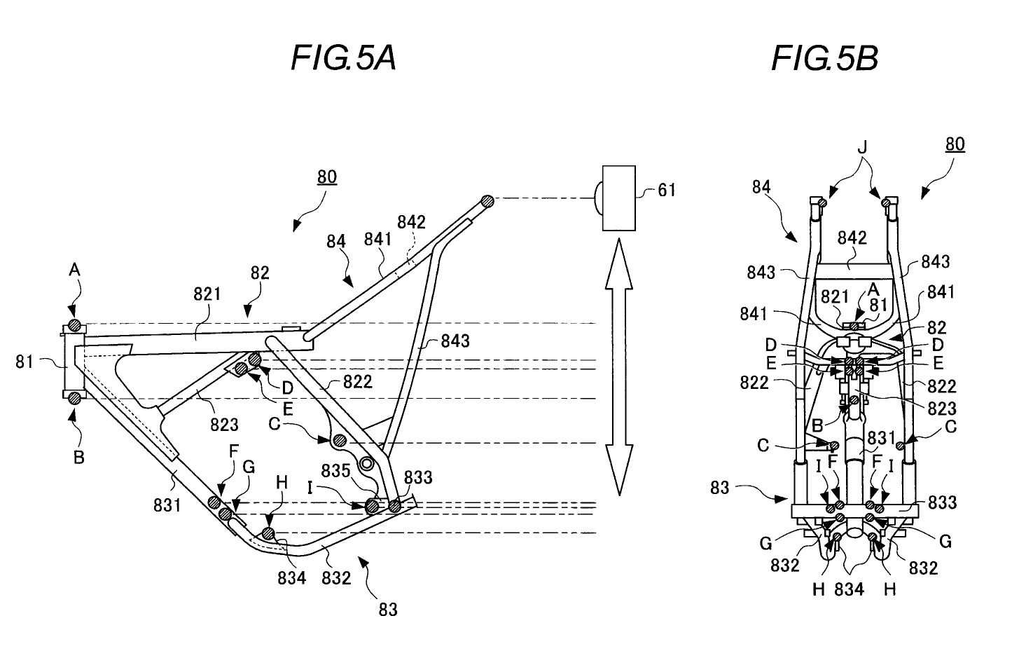

It should be noted that in the second embodiment, sensing is performed on the frame 80 with the pair of branching frames 832 of the frame 80 horizontally positioned, i.e., with the upper side portion of the head tube 81 inclined rearward, but the present invention is not limited to this structure. Alternatively, as illustrated in FIGS. 5A and 5B, sensing may be performed on the frame 80 with the head tube 81 perpendicularly positioned.

### Third Exemplary Embodiment

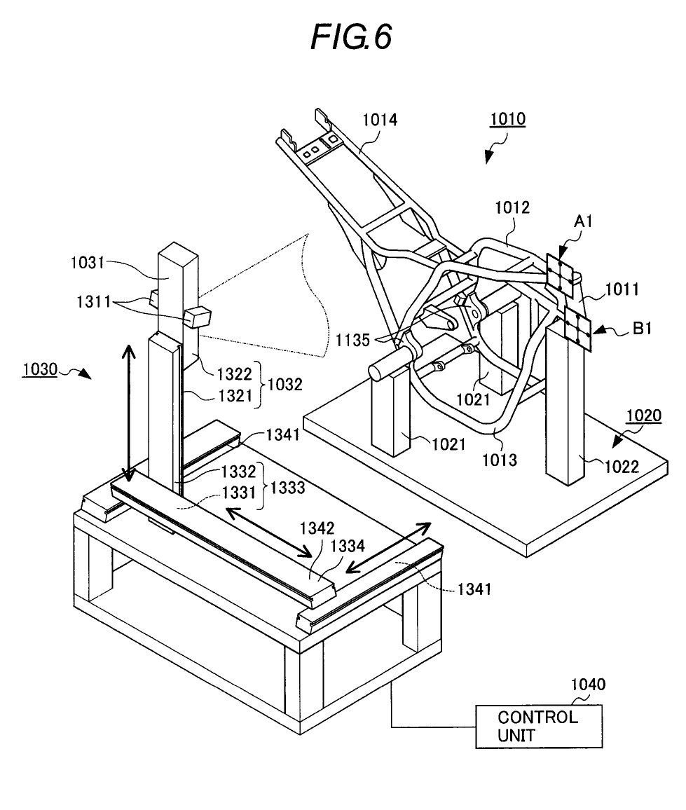

A third exemplary embodiment of the invention will be described with reference to FIGS. 6 to 8. FIG. 6 is a perspective view illustrating a frame examination system 1001 to which an accuracy control method according to the third exemplary embodiment of the present invention is applied. The frame examination system 1001 controls the accuracy of welding when a frame 1010 is finally welded. This frame examination system 1001 includes: a support device 1020 for supporting the frame 1010; a measuring device 1030 located laterally of the frame 1010; and a control unit 1040 for controlling this measuring device 1030.

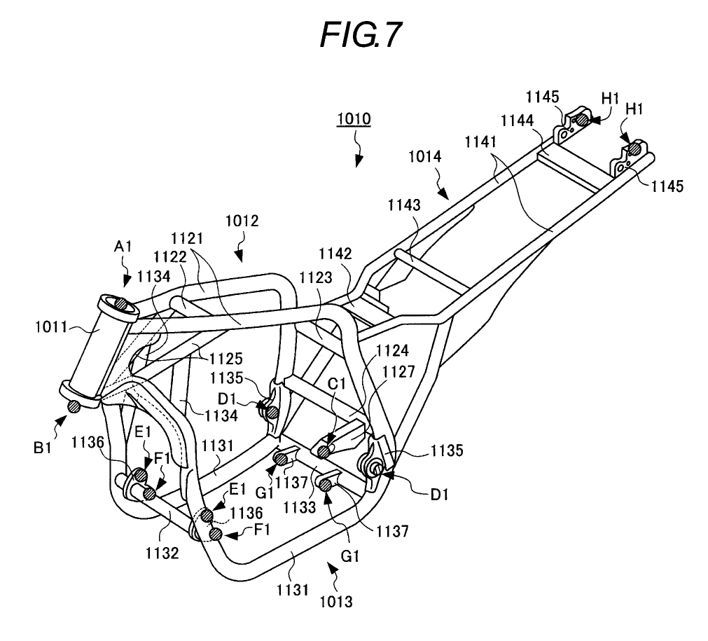

FIG. 7 is a perspective view of the frame 1010. The frame 1010 is a frame of a motorcycle, and includes the following four components: a head tube 1011; an engine upper part 1012; an engine lower part 1013; and a rear part 1014.

The head tube 1011 supports a front fork including a front wheel and a steering wheel. This head tube 1011 is formed into a cylindrical shape, and its upper side portion is inclined rearward. This head tube 1011 is provided, at its upper and lower ends, with measurement points A1 and B1, respectively.

The engine upper part 1012 includes: a pair of engine upper frames 1121 extending rearward from the head tube 1011; three connection frames 1122, 1123 and 1124 through which a pair of these engine upper frames 1121 are connected; and a pair of sub-frames 1125 extending rearward from the head tube 1011 to reach points somewhere along the pair of engine upper frames 1121.

Each engine upper frame 1121 is approximately L-shaped sc as to be extended approximately horizontally rearward from the head tube 1011 and then bent to extend downward. A protrusive piece 1127 is formed at the lowermost connection frame 1124. The protrusive piece 1127 is provided with a single measurement point C1.

The engine lower part 1013 includes: a pair of engine lower frames 1131 extending downward and rearward from the sub-frames 1125 of the engine upper part 1012; two connection frames 1132 and 1133 through which a pair of these engine lower frames 1131 are connected; and a pair of sub-frames 1134 extending from the sub-frames 1125 of the engine upper part 1012 to reach points somewhere along the pair of engine lower frames 1131. The engine lower frames 1131 are each approximately U-shaped so as to be extended downward from the head tube 1011 and subsequently bent to extend approximately horizontally rearward; then, the engine lower frames 1131 are each bent to extend upward.

The respective engine upper frames 1121 of the engine upper part 1012 abut against these engine lower frames 1131. Pivots 1135 are formed at the respective abutted portions, and the pivots 1135 are each provided with a measurement point D1.

A pair of protrusive pieces 1136 is formed at the most forward connection frame 1132, and each protrusive piece 1136 is provided with two measurement points E1 and F1. Further, a pair of protrusive pieces 1137 is formed at the lowermost connection frame 1133, and each protrusive piece 1137 is provided with a measurement point G1.

The rear part 1014 includes: a pair of rear frames 1141 extending approximately horizontally rearward from the connection frame 1123 of the engine upper part 1012; and three connection frames 1142, 1143 and 1144 through which a pair of these rear frames 1141 are connected. The respective engine lower frames 1131 of the engine lower part 1013 abut against these rear frames 1141. A pair of protrusive pieces 1145 is formed at the tip end side of the pair of rear frames 1141, and each protrusive piece 1145 is provided with a measurement point H1.

Referring again to FIG. 6, the support device 1020 includes: two first support bases 1021 for gripping the pair of pivots 1135 of the frame 1010 by horizontally inserting an unillustrated pin thereinto; and a single second support base 1022 for supporting the head tube 1011 of the frame 1010.

The measuring device 1030 measures the positions of the measurement points A1 to H1 of the frame 1010. This measuring device 1030 includes: an image-taking device 1031; a height position adjustment mechanism 1032 for adjusting the height position of this image-taking device 1031 from a floor; a first horizontal position adjustment mechanism 1333 for adjusting the position of this height position adjustment mechanism 1032 in the lengthwise direction of the frame 1010; and a second horizontal position adjustment mechanism 1334 for adjusting the position of this first horizontal position adjustment mechanism 1333 in the widthwise direction of the frame 1010.

The image-taking device 1031 is a camera, and is provided with a spotlight 1311. The height position adjustment mechanism 1032 includes: a slide rail 1321 that extends approximately perpendicularly; and a slide part 1322 that supports the image-taking device 1031 and moves along the slide rail 1321. The first horizontal position adjustment mechanism 1333 includes: a slide rail 1331 extending approximately horizontally in the lengthwise direction of the frame 1010; and a slide part 1332 that is provided with the slide rail 1321 of the height position adjustment mechanism 1032, and that moves along the slide rail 1331. The second horizontal position adjustment mechanism 1334 includes: a pair of slide rails 1341 extending approximately horizontally in the widthwise direction of the frame 1010; and a slide part 1342 that is provided with the slide rail 1331 of the first horizontal position adjustment mechanism 1333, and that moves along the slide rails 1341.

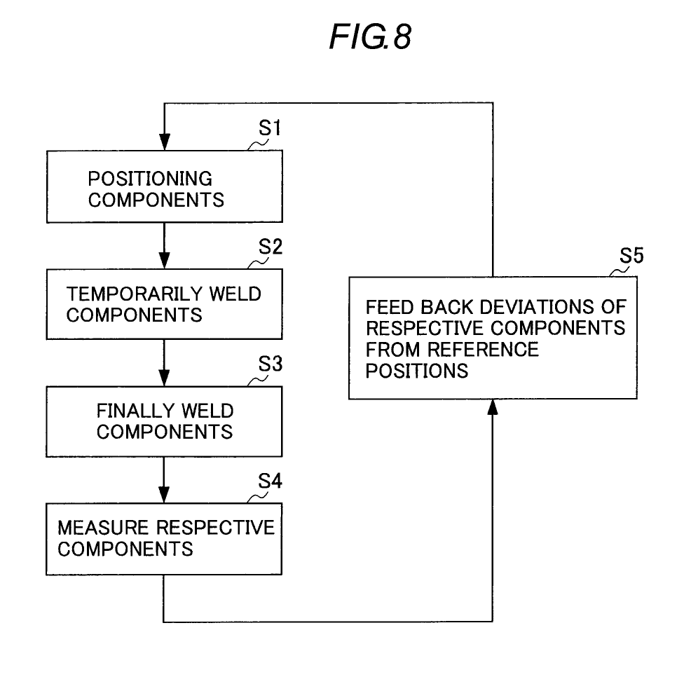

Next, a procedure for assembly of the foregoing frame 1010 will be described. As illustrated in FIG. 8, in Step S1, the components 1011 to 1014 are combined, and the relative positions and/or postures thereof are adjusted, thereby positioning the components 1011 to 1014. In Step S2, the positioned components 1011 to 1014 are temporarily welded to each other. In Step S3, the temporarily welded components 1011 to 1014 are finally welded to each other. In Step S4, as illustrated in FIG. 8, the measuring device 1030 is driven by the control unit 1040 to measure the measurement points A1 to H1 of the finally welded components 1011 to 1014, thus determining deviations of the measurement points A1 to H1 of these components 1011 to 1014 from the reference positions. And in Step S5, the determined deviations are fed back to Step S1, which is the positioning step. For example, if the positions of the measurement points A1 to H1, on which the measurements have been made, are deviated to the right from the reference positions, the positions of the measurement points A1 to H1 is adjusted in the positioning step so that the measurement points A1 to H1 are deviated to the left with respect to the reference positions.

According to the third exemplary embodiment, a plurality of the components 1011 to 1014 are positioned, and the positioned components 1011 to 1014 are temporarily welded to each other. Subsequently, the temporarily welded components 1011 to 1014 are finally welded to each other, and the measurement points A1 to H1 of the finally welded components 1011 to 1014 are measured. Then, deviations of the measurement points A1 to H1 from the reference positions are determined, and the determined deviations are fed back to the positioning step S1. As described above, since the deviations measured after the final welding are fed back to the positioning S1, the deviations of the components 1011 to 1014 can be prevented from falling outside the allowable range after the final welding.

### Fourth Exemplary Embodiment

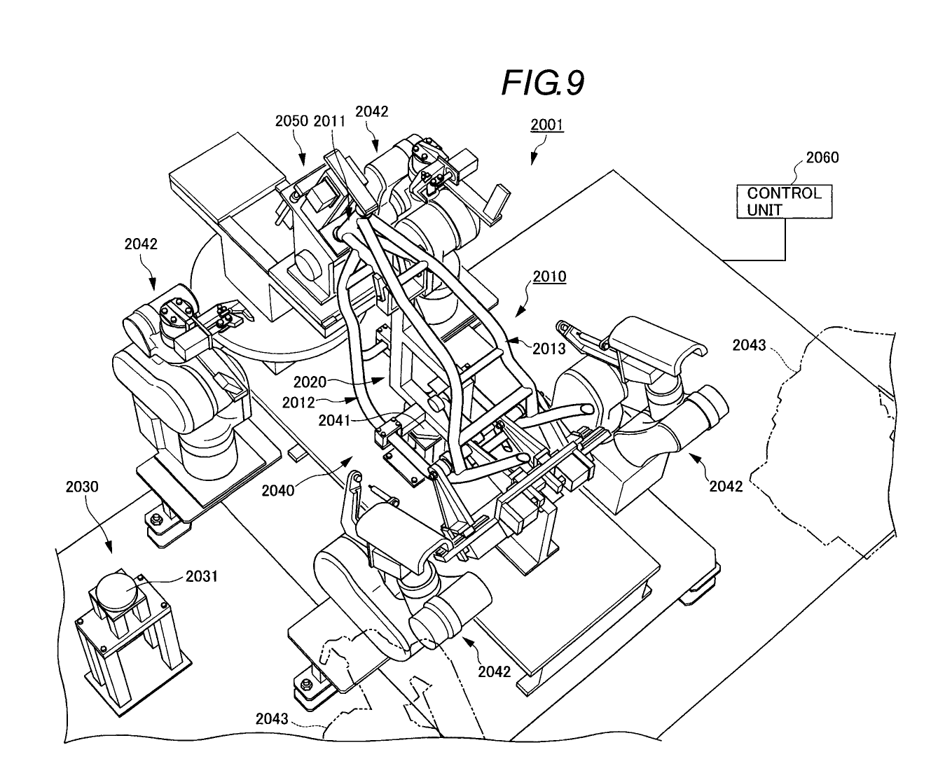

A fourth exemplary embodiment will be described with reference to FIGS. 9 to 13. FIG. 9 is a perspective view schematically illustrating a frame welding system 2001 serving as a workpiece positioning system according to the fourth exemplary embodiment of the present invention. The frame welding system 2001 adjusts the relative positions and postures of components 2011, 2012 and 2013 that serve as three workpieces constituting a frame 2010 set onto a support jig 2020, and then welds the components 2011, 2012 and 2013 to each other. This frame welding system 2001 includes: a preset area 2030 serving as a first area; and a welding area 2040 serving as a second area provided so as to be adjacent to this preset area 2030.

In the preset area 2030, a support device 2031 for supporting the support jig 2020 is provided. In the welding area 2040, there are provided: a support device 2041 for supporting the support jig 2020; and a gripping device 2050, four five-axis gripping robots 2042 and two welding robots 2043, which are located so as to surround this support device 2041.

Further, a control unit 2060 functioning as a control part controls: the support jig 2020 supported by these support device 2031 and support device 2041; the gripping device 2050; the four five-axis gripping robots 2042; and the two welding robots 2043.

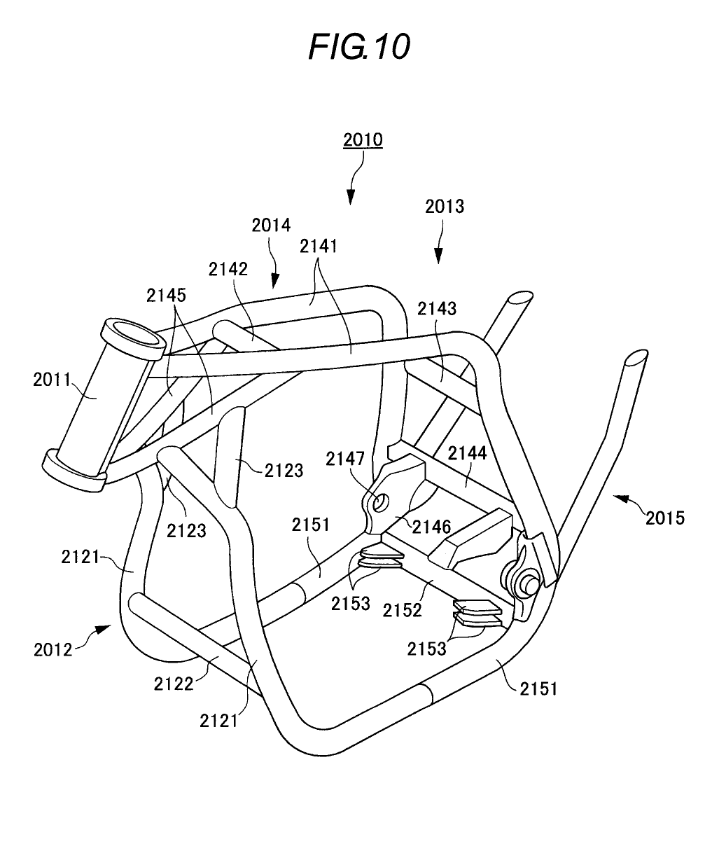

FIG. 10 is a perspective view of the frame 2010. The frame 2010 is a frame of a motorcycle, and includes the following three components: a head tube 2011; an engine front lower part 2012; and a main part 2013. Among these components, the main part 2013 includes: an engine upper part 2014; and an engine rear lower part 2015.

The head tube 2011 supports a front fork including a front wheel and a steering wheel. This head tube 2011 is formed into a cylindrical shape, and its upper side portion is inclined rearward.

The engine front lower part 2012 includes: a pair of engine front lower frames 2121 extending downward and rearward from the main part 2013; a single connection frame 2122 through which a pair of these engine front lower frames 2121 are connected; and a pair of sub-frames 2123 extending from the main part 2013 to reach points somewhere along the pair of engine front lower frames 2121. Each engine front lower frame 2121 is approximately L-shaped so as to be extended downward from the head tube 2011 and then bent to extend approximately horizontally rearward.

The engine upper part 2014 includes: a pair of engine upper frames 2141 extending rearward from the head tube 2011; three connection frames 2142, 2143 and 2144 through which a pair of these engine upper frames 2141 are connected; and a pair of sub-frames 2145 extending rearward from the head tube 2011 to reach points somewhere along the pair of engine upper frames 2141.

Each engine upper frame 2141 is approximately L-shaped so as to be extended approximately horizontally rearward from the head tube 2011 and then bent to extend downward. A protrusive piece 2146 is formed at the lowermost connection frame 2144, and a through hole 2147 is formed in this protrusive piece 2146. Furthermore, the foregoing engine front lower frames 2121 and sub-frames 2123 are extended from the sub-frames 2145 of the main part 2013.

The engine rear lower part 2015 includes: a pair of engine rear lower frames 2151 extending rearward and upward from tips of the pair of engine front lower frames 2121; and a single connection frame 2152 through which a pair of these engine rear lower frames 2151 are connected. Each engine rear lower frame 2151 is approximately L-shaped so as to be extended approximately horizontally rearward from the tips of the engine front lower frames 2121 and then bent to extend upward. The respective engine upper frames 2141 of the engine upper part 2014 abut against these engine rear lower frames 2151. A pair of protrusive pieces 2153 opposed to each other is formed at each of two positions of the connection frame 2152.

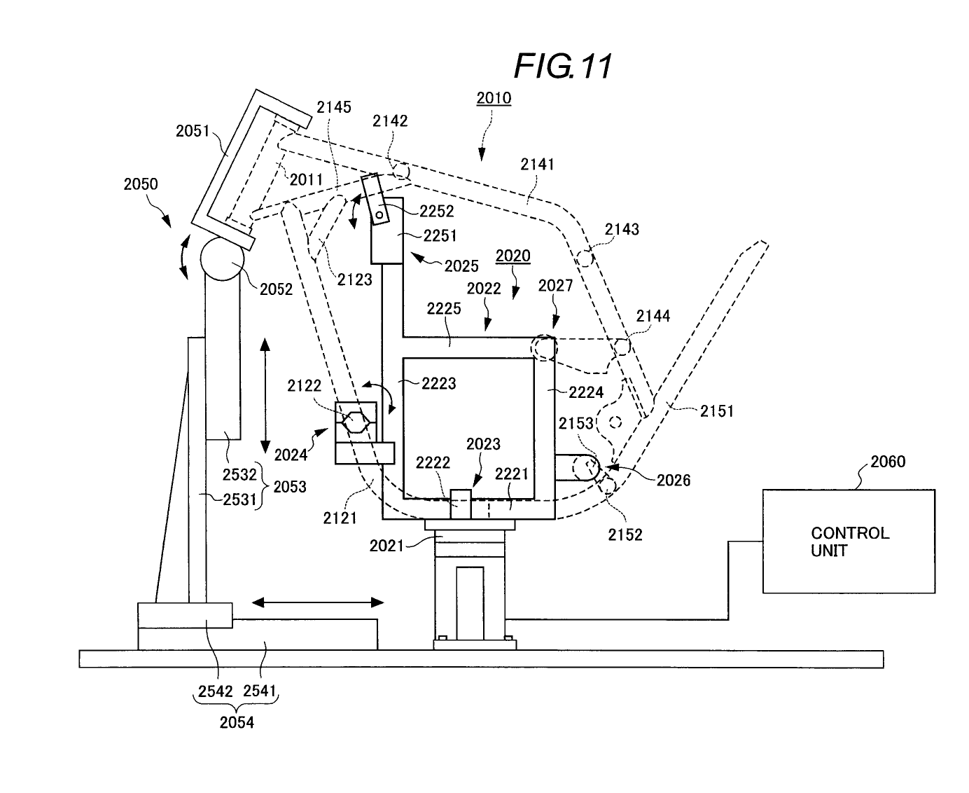

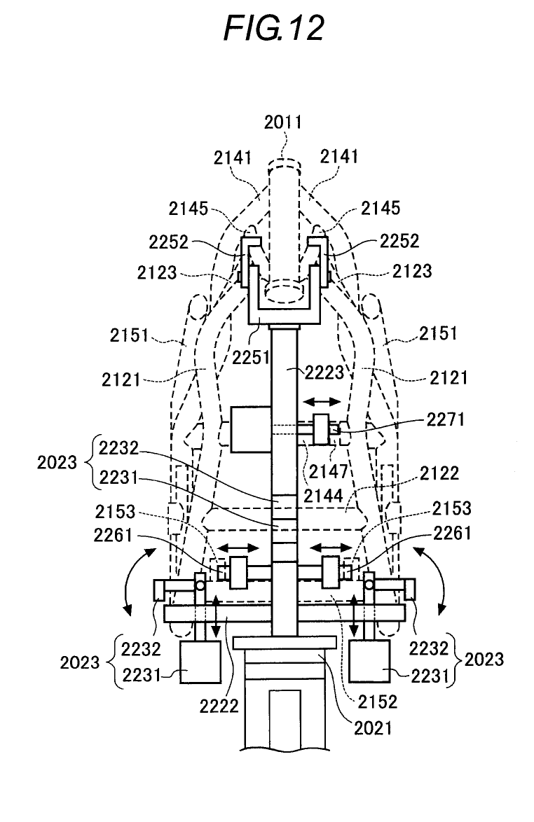

FIG. 11 is a side view of the support jig 2020, and FIG. 12 is a front view of the support jig 2020. The support jig 2020 supports the frame 2010 of a motorcycle, and includes: a detachable/attachable part 2021 detachable/attachable from/to the support devices in the preset area and the welding area; a jig main body 2022 provided over this detachable/attachable part 2021; and first, second, third, fourth and fifth holding parts 2023, 2024, 2025, 2026 and 2027 for holding the frame 2010, which are provided at this jig main body 2022.

The jig main body 2022 includes: a first frame 2221 provided over the detachable/attachable part 2021 and extending in the lengthwise direction of the frame 2010; a pair of second frames 2222 extending in the widthwise direction of the frame 2010 from lateral faces of this first frame 2221; a third frame 2223 extending approximately perpendicularly upward from one end of the first frame 2221; a fourth frame 2224 extending approximately perpendicularly upward from the other end of the first frame 2221; and a fifth frame 2225 extending in the lengthwise direction of the frame 2010 from an upper end of this fourth frame 2224 to reach a point somewhere along the third frame 2223.

The first holding part 2023 is provided at a tip of each of the pair of second frames 2222, and the first holding parts 2023 each include: a base portion 2231 fixed to the tip of the second frame; and a lid portion 2232 provided at this base portion 2231 so as to be vertically openable/closable. The first holding parts 2023 hold the engine front lower part 2012 in the following manner. The lid portions 2232 are closed with the engine front lower frames 2121 located over the base portions 2231, and the engine front lower frames 2121 of the engine front lower part 2012 are vertically sandwiched between the base portions 2231 and the lid portions 2232, thereby holding the engine front lower part 2012.

The second holding part 2024 is provided at a lower portion of the third frame 2223. This second holding part 2024 has a structure similar to that of the first holding part 2023, and vertically sandwiches the connection frame 2122 of the engine front lower part 2012, thereby holding this engine front lower part 2012.

The third holding part 2025 is provided at an upper end of the third frame 2223, and includes: a support frame 2251 extending in the widthwise direction of the frame 2010 from the upper end of the third frame 2223; and a pair of engagement pieces 2252 provided at ends of this support frame 2251 so as to be rotatable around a rotation axis extending in the widthwise direction of the frame 2010. The third holding part 2025 sandwiches the pair of sub-frames 2145 of the main part 2013 from outside by rotating the pair of engagement pieces 2252, thus holding the main part 2013.

The fourth holding part 2026 is provided somewhere along the fourth frame 2224, and includes a pair of pins 2261 moved forward/backward in the widthwise direction of the frame 2010. The pair of pins 2261 is inserted between each pair of protrusive pieces 2153 of the main part 2013, and thus this fourth holding part 2026 holds this main part 2013.

The fifth holding part 2027 is provided at one lateral face of the upper end of the fourth frame 2224, and includes a pin 2271 moved forward/backward in the widthwise direction of the frame 2010. The pin 2271 is inserted into the through hole 2147 of the main part 2013, and thus this fifth holding part 2027 holds this main part 2013.

The gripping device 2050 adjusts the position and posture of the head tube 2011 of the frame 2010. This gripping device 2050 includes: a gripping part 2051 for gripping the head tube 2011; an inclination adjustment mechanism 2052 for adjusting the inclination of this gripping part 2051; a height position adjustment mechanism 2053 for adjusting the height position of this inclination adjustment mechanism 2052 from a floor; and a horizontal position adjustment mechanism 2054 for adjusting the approximate horizontal position of this height position adjustment mechanism 2053.

The inclination adjustment mechanism 2052 causes the gripping part 2051 to be rotated around the axis extending in the widthwise direction of the frame 2010. The height position adjustment mechanism 2053 includes: a slide rail 2531 that extends approximately perpendicularly; and a slide part 2532 that supports the inclination adjustment mechanism 2052 and moves along the slide rail 2531. The horizontal position adjustment mechanism 2054 includes: a slide rail 2541 provided on the floor and extending approximately horizontally; and a slide part 2542 that supports the slide rail 2531 of the height position adjustment mechanism 2053 and moves along the slide rail 2541.

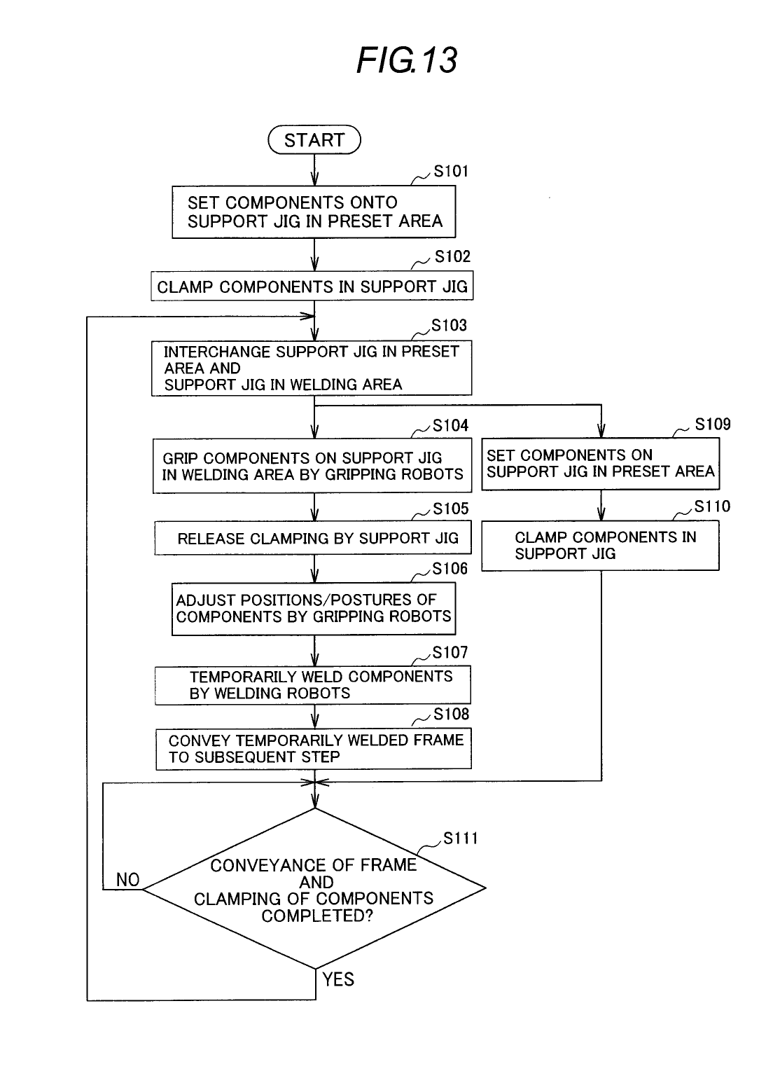

Next, operations of the foregoing frame welding system 2001 will be described with reference to the flow chart of FIG. 13. Initial settings are made so that the support device 2031 in the preset area 2030 is equipped with the support jig 2020, and the support device 2041 in the welding area 2040 is equipped with another support jig 2020. In Step S101, a worker places the components 2011 to 2013, which are in the combined state, onto the support jig 2020 in the preset area 2030.

In Step S102, the holding parts 2023 to 2027 of the support jig 2020 are driven by the control unit 2060, thereby clamping the components 2011 to 2013. More specifically, first, the engine front lower part 2012 is set, and the holding parts 2023 and 2024 are driven, thereby holding this engine front lower part 2012. Then, the head tube 2011 and the main part 2013 are set, and the holding parts 2025 to 2027 are driven, thereby holding the main part 2013.

In Step S103, the control unit 2060 releases the holding of the support device 2031 in the preset area 2030 and the support device 2041 in the welding area 2040, and controls the four gripping robots 2042, thereby interchanging the support jig 2020 in the preset area 2030 and the support jig 2020 in the welding area 2040.

Thus, the components 2011 to 2013 are set onto the support jig 2020 in the welding area 2040; therefore, in Step S104, the control unit 2060 controls the gripping device 2050 to grip the component 2011, and controls the four gripping robots 2042 to grip the components 2012 and 2013 placed on the support jig 2020 in the welding area 2040.

In Step S105, the holding parts 2023 to 2027 of the support jig 2020 other than the holding part 2026 are driven by the control unit 2060, thereby releasing the clamping of the components 2011 to 2013 carried out by the support jig 2020. More specifically, the holding parts 2023 and 2024 are driven to release the holding of the engine front lower part 2012, and the holding parts 2025 and 2027 are driven to release the holding of the main part 2013.

In Step S106, the gripping device 2050 is controlled by the control unit 2060 to make fine adjustments of the position and posture of the component 2011, and fine adjustments of the relative positions and/or postures of the components 2012 and 2013 are made by the gripping robots 2042. In this case, the adjustments are made by using, as an accuracy criterion, the connection frame 2152 of the main part 2013 held by the holding part 2026.

In Step S107, with the fine adjustments made by the gripping device 2050 and the gripping robots 2042, the two welding robots 2043 are controlled by the control unit 2060, thus temporarily welding abutted portions of these components 2011 to 2013.

In Step S108, the gripping robots 2042 are controlled by the control unit 2060, thereby conveying the temporarily welded components 2011 to 2013 from the welding area 2040 to an area for the subsequent step (final welding).

On the other hand, upon completion of Step S103, the support jig 2020 in the preset area 2030 enters a state in which the components 2011 to 2013 are removed therefrom. Therefore, in Step S109, similarly to Step S101 described above, a worker places different components 2011 to 2013, which are in the combined state, onto the support jig 2020 in the preset area 2030.

In Step S110, similarly to Step S102 described above, the holding parts 2023 to 2027 of the support jig 2020 are driven by the control unit 2060, thereby clamping the different components 2011 to 2013 and putting the operation on standby.

In Step S111, it is determined whether or not the conveyance of the components 2011 to 2013 from the welding area 2040 has been completed in Step S108 and the holding of the different components 2011 to 2013 by the support jig 2020 has been completed in Step S110. When the determination result is NO, Step S111 is repeated, and when the determination result is YES, the process returns to Step S103.

As described above, while the relative positions and postures of the components 2011 to 2013 are adjusted and welding operations are performed thereon in the welding area 2040, an operation for setting the different components 2011 to 2013 onto the support jig 2020 is carried out in the preset area 2030.

According to the fourth exemplary embodiment, the components 2011 to 2013 are combined by a worker using the support jig 2020, and then the relative positions and/or postures of these components 2011 to 2013 are adjusted by the plurality of gripping robots 2042. Hence, it is only necessary to adjust the relative positions and/or postures of the components 2011 to 2013, which have already been combined, by the gripping robots 2042. Consequently, as compared with a conventional case in which workpieces are combined by robots, the operations of the gripping robots 2042 can be more simplified, and therefore, the components 2011 to 2013 can be easily positioned.

Further, since the components 2011 to 2013 can be positioned just by using the gripping robots 2042 and the support jig 2020, the system's versatility is enhanced. Furthermore, during the period when the relative positions and/or postures of the components 2011 to 2013 are adjusted in the welding area 2040, an operation for placing the different components 2011 to 2013 onto the support jig 2020 can be carried out in the preset area 2030, thus enabling an improvement in operating efficiency.

Moreover, upon conveyance of the welded components 2011 to 2013 to the area for the subsequent step, the support jig 2020 remains in the welding area 2040. Hence, this support jig 2020 is utilized again, and thus it is only necessary to prepare the two support jigs 2020 in total, which results in a reduction in manufacturing cost.

### DESCRIPTION OF REFERENCE NUMERALS AND SIGNS

A to J measurement point (predetermined spot)
R to U target plate (target)
10 frame
50 third gripping robot
51 hand
60 measuring device (sensing device)
1011 head tube (workpiece)
1012 engine upper part (workpiece)
1013 engine lower part (workpiece)
1014 rear part (workpiece)
2001 frame welding system (workpiece positioning system)
2011 to 2013 component (workpiece)
2030 preset area (first area)
2040 welding area (second area)
2042 gripping robot
2020 support jig
2060 control unit (control part)

What is claimed is:

1. A workpiece positioning system for positioning a plurality of workpieces, the system comprising:
a plurality of robots capable of holding the plurality of workpieces in a condition where the plurality of workpieces are combined; and
a control part for controlling the plurality of robots,
wherein the control part is configured to control the plurality of robots so as to grip the plurality of workpieces.

2. A workpiece positioning method for positioning a plurality of workpieces, the method comprising:
holding the plurality of workpieces by a plurality of robots in a condition where the plurality of workpieces are combined; and
adjusting relative positions and postures of the plurality of workpieces by the plurality of robots.

3. A workpiece positioning system for positioning a plurality of workpieces, the system comprising:
a plurality of robots;
a support jig capable of holding or releasing the plurality of workpieces in a condition where the plurality of workpieces are combined; and
a control part for controlling the plurality of robots and the support jig,
wherein the control part is configured to control the plurality of robots so as to grip the plurality of workpieces placed on the support jig, and to control the support jig so as to release the holding of the plurality of workpieces gripped by the plurality of robots.

4. A workpiece positioning method for positioning a plurality of workpieces, the method comprising:
disposing a support jig in a first area;
placing the plurality of workpieces over the support jig, in a condition that the plurality of workpieces combined;
causing the support jig to hold the plurality of workpieces;
conveying the support jig holding the plurality of workpieces to a second area;
gripping the plurality of workpieces placed on the support jig by a plurality of robots;
releasing the holding of the plurality of workpieces carried out by the support jig; and
adjusting relative positions and postures of the plurality of workpieces placed on the support jig by the plurality of robots.

5. The workpiece positioning method according to claim 4, the method further comprising:
welding joints of the workpieces to each other after the relative positions and postures of the plurality of workpieces have been adjusted; and
conveying the welded workpieces to an area for a subsequent step by at least one of the plurality of robots.

6. An accuracy control method for controlling accuracy when a plurality of workpieces are assembled and welded, the method comprising:
positioning the plurality of workpieces;
temporarily welding the positioned workpieces to each other;
finally welding the temporarily welded workpieces to each other; and
measuring the finally welded workpieces to determine deviations of the workpieces from reference positions, and feeding back the determined deviations to the step of positioning.

7. A sensing method for determining positions of predetermined spots in a frame of a motorcycle, the method comprising:
performing sensing on all the predetermined spots in one direction from a front side or a rear side of the frame of the motorcycle by a sensing device.

8. The sensing method according to claim 7, wherein the sensing is performed from the rear side of the frame by the sensing device.

9. The sensing method according to claim 7, further comprising:
preparing robots having hands each provided with a target;
gripping the frame by the hands of the robots;
performing sensing of the targets by the sensing device, in a condition that the frame is gripped by the hands of the robots; and
determining the positions of the predetermined spots based on results obtained by the sensing.
